(19) United States
(12) Patent Application Publication
(10) Pub. No.: US 2019/0243953 A1
(43) Pub. Date: Aug. 8, 2019

(54) ENHANCED SECURITY FOR MULTIPLE NODE COMPUTING PLATFORM

(71) Applicant: Intel Corporation, Santa Clara, CA (US)

(72) Inventors: Farah E. FARGO, Hudson, MA (US); Olivier FRANZA, Brookline, MA (US); Amit KUMAR, Marlborough, MA (US)

(21) Appl. No.: 16/271,258

(22) Filed: Feb. 8, 2019

(51) Int. Cl. G06F 21/14; G06F 21/60; G06F 8/40

(52) U.S. Cl. CPC G06F 21/14; G06F 8/40; G06F 21/602

(57) ABSTRACT

A computing node can execute a controller in a secure and trusted environment. The controller can cause a task to be executed on different nodes with differing computing platform software and an executable derived from a different coding language. The controller can detect anomalies in results from performance of the task using the different nodes. Any node with an anomalous result can be excluded from use and considered compromised by intrusion. The controller can also at some time interval or a pseudo-random time interval, change computing software settings and/or coding language used for applications on the node.

### TECHNICAL FIELD

Various examples are described herein that relate to intrusion deterrence for multiple node computing systems.

### BACKGROUND

Data centers provide vast processing, storage, and networking resources to users. For example, client devices can leverage data centers to perform image processing, computation, data storage, and data retrieval. A client device such as a smart phone, Internet-of-Things (IoT) compatible device, a smart home, building appliance (e.g., refrigerator, light, camera, or lock), wearable device (e.g., health monitor, smart watch, or smart glasses), connected vehicle (e.g., self-driving car or flying vehicle), and smart city sensor (e.g., traffic sensor, parking sensor, or energy use sensor). Data and platform security are needed to prevent intrusion into data centers and computing devices that could cause device failures, steal personal information, access data, and other disruptive or illegal activities.

### BRIEF DESCRIPTION OF THE DRAWINGS

FIG. 1A depicts an example computing system.

FIG. 1B depicts an example environment.

FIG. 2 depicts an example of an anomaly detection system.

FIG. 3 depicts an example of attack phases.

FIGS. 4A and 4B depict an example process.

FIG. 4C depicts an example process.

FIGS. 5A and 5B depict experimental results.

FIG. 6 depicts an example system.

FIG. 7 depicts an example of a data center.

### DETAILED DESCRIPTION

Generally speaking, there are two type of intrusion detection categories, namely, signature-based and anomaly-based. Signature-based techniques attempt to secure computing systems against known patterns of attacks by recognizing attacks using pattern-matching algorithms and comparing network traffic with a library of attack signatures. However, signature-based intrusion detection techniques are not able to identify new and unknown attacks as soon as they occur.

Anomaly-based intrusion techniques can be used to identify intrusions to a system based on deviations from the system's normal behavior. Anomaly-based intrusion techniques build a model of normal behavior and automatically classify statistically significant deviations from normal behavior as being abnormal. Using this technique makes it is possible to detect new attacks, but there can be a high rate of false positive alarms generated when the knowledge collected about normal behavior is inaccurate.

Resiliency, by definition, involves software and hardware components tolerating possible successful attacks, misconfigurations, failures, faults, and so on. To attempt to provide resiliency, several methods are available, namely, redundant operating stations with hardware or software result comparisons, distributed recovery block with an acceptance test, triple modular voting and redundant computing stations, as well as N-version programming where different versions are created and executed. Furthermore, Moving Target Defense (MTD), address space randomization, instruction set randomization, and data randomization techniques have been known to have been applied.

As High Performance Computing (HPC) moves to the cloud environment, cybersecurity against unauthorized intrusion is a challenge due to the integration of computer networks, virtualization, multi-tenant occupancy, remote storage, and so forth. According to some embodiments, computing environments (e.g., HPC fabrics) can provide for executing duplicate processes on different platforms such that the duplicate processes perform the same functions but using different programming languages and different platform software (e.g., different operating systems). Results (e.g., latency and computational results) provided from multiple duplicate processes can be compared against each other and an expected result. For example, results can include one or more of: a computation result value or values, how much memory is used, central processing unit (CPU) or core utilization, input/output utilization, a secure shell (SSH) key from nodes (e.g., Partition Key (PKey)). Any anomalous result can be determined to be attributed to an intrusion and that platform is disabled. In some cases, the anomalous system can potentially be turned off or disconnected from the other nodes.

At a time interval or at pseudo-random intervals, the software platform is altered and changed to a different software platform. For example, a platform executing Linux operating system is changed to run Microsoft Windows Server, another platform executing Microsoft Windows Server can be changed to run UNIX, and so forth. In addition, the processes running on each platform are modified to execute binaries based on a different programming language. For example, a platform executing a Java-based process can instead execute a C++ based process. In some cases, the change in platform software and programming language can be selected pseudo-randomly so that any attempted change in platform software or programming language will not necessarily yield a change.

If an attacker gains any information about the vulnerability of one system, after a platform software or programming language change, the existing vulnerabilities may no longer exist. Additionally, with redundancy of processes (e.g., duplicate processes), even if a system fails or is compromised, the processes continue operating and can perform workload requests from clients, other devices, or processes.

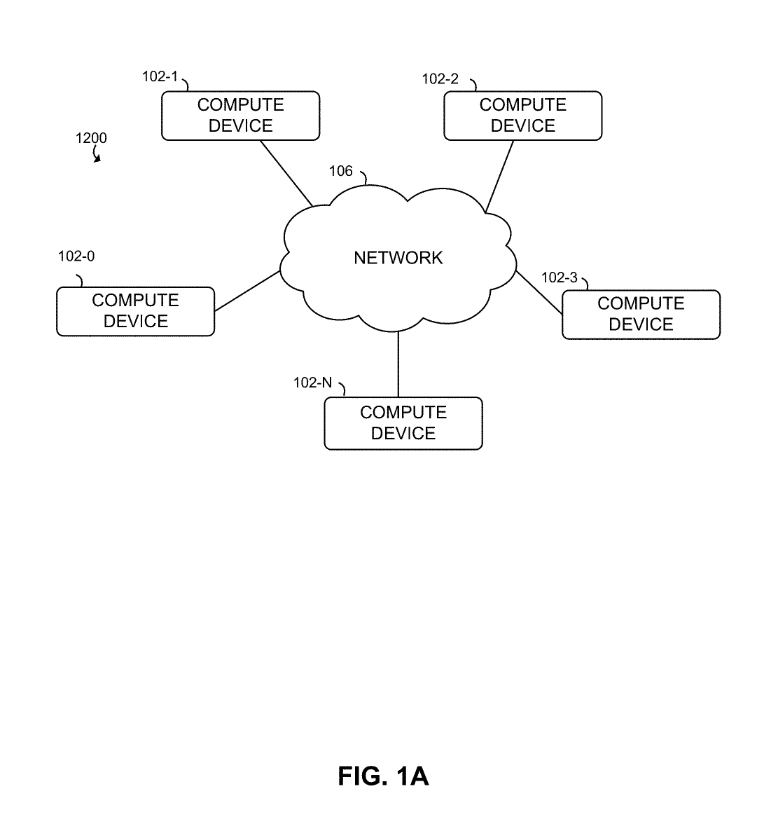

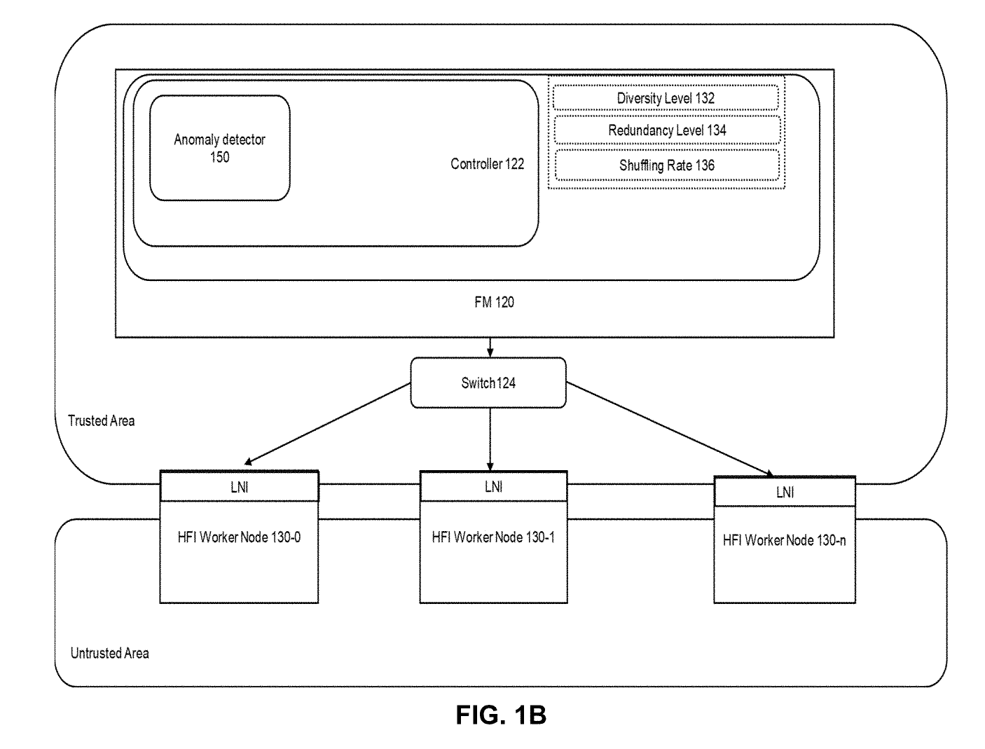

FIG. 1A depicts an example computing system whereby compute devices 102-0 to 102-N are communicatively coupled using a network 106. For example, network 106 can be one or a combination of: a high-speed fabric (e.g., Intel Omni-Path), optical network, Ethernet compatible network, or interconnect using PCIe interfaces. Switches (not depicted) can provide communicative coupling between compute devices 102-0 to 102-N and network 106. Compute devices 102-0 to 102-N can offer one or more of: central processing units, cores, graphics processing units, execution units, field programmable gate arrays (FPGAs), programmable control logic (PLCs), accelerators, volatile or non-volatile memory, or network interface capabilities. For example, the computing system can permit deployment of a computing platform (e.g., virtual machine or container), service or workload on one or more other compute devices 102-0 to 102-N.

FIG. 1B depicts an example environment that can attempt to resist intrusion into any process or platform. In this example, a computing platform can provide a trusted area where a Host Fabric Interface (HFI) node executes a fabric manager (FM) 120. For example, FM 120 can perform one or more of: maintain connectivity with nodes using a switch 124, manage a fabric, attempt to maintain connectivity among all nodes, attempt to maintain connectivity of all nodes to a switch, setup of connectivity, and so forth. FM 120 provides centralized provisioning and monitoring of fabric resources such as other nodes and computing resources. FM 120 provides, invokes, or uses a controller process 122 to supervise at least a software platform (e.g., operating system, file system accepted programming languages, applied core or processor clock frequency, allocated volatile or non-volatile memory, allocated network interface speed, and so forth) and accepted computing languages for execution on other nodes 130-0 to 130-n. Nodes 130-0 to 130-n could be heterogeneous or homogeneous nodes with respect to computing resources, memory, network interfaces, and so forth. Using heterogeneous resources can help provide diversity to the system that can be difficult to detect by intruders so that the operating performance of multiple nodes in the system can be difficult to determine. Nodes 130-0 to 130-n can use Link Negotiation and Initialization (LNI) to communicate with the FM 120.

A trusted area can be region of memory or a processor or both that are not connected to Internet or a network and not accessible by other processes except for FM 120. For example, a trusted area can be a secure enclave or an Intel Software Guard Extensions (SGX) allocated enclave. For example, the trusted area can store diversity level 132, redundancy level 134, and shuffling rate 136. Controller process 122 can access information in diversity level 132, redundancy level 134, and shuffling rate 136 to determine when and how to modify a software environment in any of nodes 130-0 to 130-n.

Diversity level 132, redundancy level 134, and shuffling rate 136 specify respectively, a number of nodes to perform a same or similar workload, differences in versions of the applications and operating platforms, and frequency that each execution environment will be potentially modified. Using Application Resilient Editor (ARE), a user or administrator can define content of the diversity level 132, redundancy level 134, and shuffling rate 136. Based on the specified configurations, controller process 122 can configure the environment with the redundancy level of nodes and the parameter change frequency. Note that shuffling rate 136 can be set to change and not be a consistent period and can be pseudo-random selected time intervals.

Controller process 122 can access fabric manager data to distribute workloads and jobs to two or more nodes among nodes 130-0 to 130-n using a network, interconnect, or fabric. In one example, controller 122 causes at least two of nodes 130-0 to 130-n to execute different software platforms, accept different programming languages, or operate at different performance requirements. Examples of software platforms include operating systems (e.g., Windows, Linux, iOS, MacOS, any other operating system, including different version numbers of the same operating system), virtual machine, file system. Examples of programming languages include C, C++, Java, Python, JavaScript, and any other computing language. Examples of performance requirements include one or more of: CPU clock speed, GPU clock speed, memory allocation, storage allocation, or network interface transmit and receive rates.

For example, controller 122 can direct node 130-0 to execute a Windows Server Operating System and accept applications written in Java whereas controller 122 can direct node 130-1 can execute a Linux operating system and accept applications written in C. Controller 122 can dispatch the same workload, in compiled format, based on one workload written in Java and the other workload written in C to respective nodes 130-0 and 130-1. Controller 122 can use communicate with other nodes and use a Partition Key (PKey) (e.g., Omni-Path PKey) (and vice versa) that prevents against undesirable communication between nodes and will can spoofing the controller.

After a workload is submitted by controller 122 to two or more of nodes 130-0 to 130-n, nodes will perform the workload and provide results that are accessible to controller 122. Controller 122 can collect the results and apply a voting mechanism technique to identify any anomalous node. For example, a controller 122 can review workload results by a main node and redundant nodes, compare workload results, and if a majority of results are the same, then any different result is considered to be an anomaly. A majority of results can occur when most of the results are the same even though a majority of nodes do not provide the same result. For example, if 10 nodes provide results and 4 of the nodes provide the same result, and 6 of the nodes provide different results, the results from the 4 nodes can be considered majority. A majority can occur when a majority of nodes provide the same result. For example, if 10 nodes provide results, a majority occurs when the 6 of the nodes provide the same result. For example, results can include one or more of: a computation result value or values, how much memory is used, central processing unit (CPU) or core utilization, input/output utilization, a secure shell (SSH) key from nodes (e.g., partition key (PKey)). If there is no majority of results, then controller 122 can consider all nodes that performed the workload and provided the results to be compromised.

In addition, time to complete a workload can be compared against one another to determine if any node took too long to complete a workload. If a result takes longer than expected to be received from a node, the behavior of the node can be considered abnormal. Results and latency of operation (e.g., time to complete a workload) from nodes can be stored and compared against most recently received results and latency to determine if any node exhibits abnormal behavior compared against one or more prior results or latency of operation. In some cases, if a result or latency is sufficiently different than one or more prior results or latency of operation for a same or similar prior workload, any node that provided workload sufficiently different results or exhibited sufficiently different latency can be considered compromised even if a majority of nodes demonstrated the same results or latency.

Controller 122 can disconnect and deactivate any associated node that provided the anomalous result or latency. Controller 122 can associate an anomalous result or latency with unauthorized intrusion. Deactivating the node can potentially prevent an unauthorized intruder from comprising the system as a whole or other nodes.

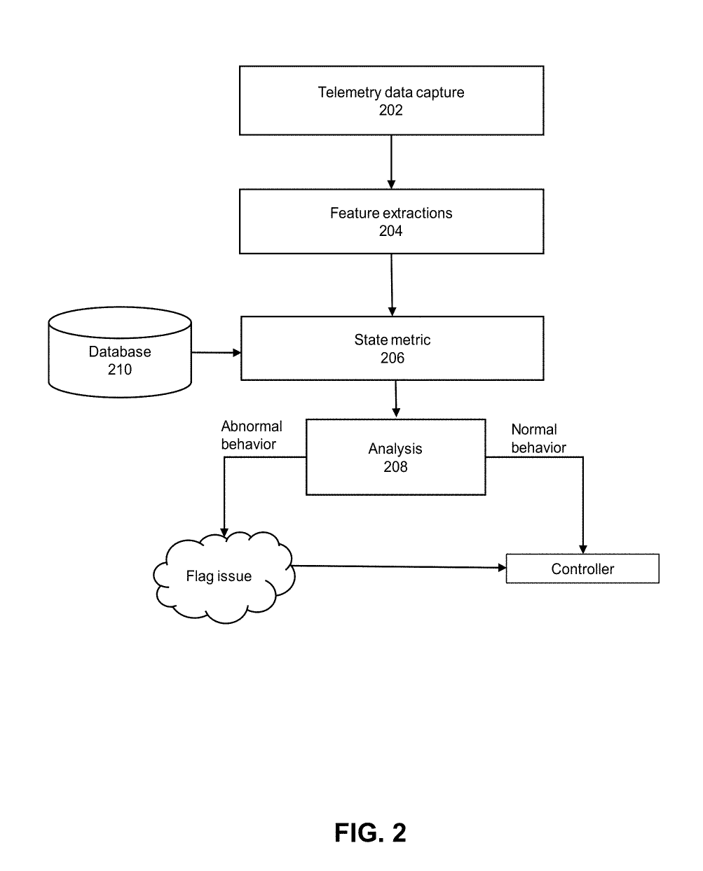

Anomaly detector 150 can define normal and abnormal behavior and update the ruleset as needed to modify intrusion detection ability. FIG. 2 depicts an example of an anomaly detection system that can be used by an anomaly detector. Anomaly detector can capture telemetry data using telemetry data capture 202 during the workload execution by other nodes and analyze the monitored data at runtime (e.g., results or latency data). According to some embodiments, multiple redundant channels can be used to collect data from a single node (e.g., telemetry data, results, latency, operating conditions, and so forth). Telemetry data can include one or more of: processor or core usage statistics, input/output statistics for devices and partitions, memory usage information, storage usage information, bus or interconnect usage information, processor hardware registers that count hardware events such as instructions executed, cache-misses suffered, or branches mis predicted. For a workload request that is being performing or has completed, one or more of the following can be collected: telemetry data such as but not limited to outputs from Top-down Micro-Architecture Method (TMAM), execution of the Unix system activity reporter (sar) command, Emon command monitoring tool that can profile application and system performance. However, additional information can be collected such as outputs from a variety of monitoring tools including but not limited to output from use of the Linux perf command, Intel PMU toolkit, Iostat, VTune Amplifier, or monCli or other Intel Benchmark Install and Test Tool (Intel® BITT) Tools. Other telemetry data can be monitored such as, but not limited to, power usage, inter-process communications, and so forth.

The gathered historic behavior data (e.g., results or latency data) can be used for the identification of whether behavior is considered normal or abnormal. Feature extractions 204 extracts the monitored features and retrieves the closest case from database 210 (e.g., same job, same programming language, same software platform) and compares the results and latency using state metric block 206. If the analyzed data is within 1% of in terms of latency and an exact match in result, the node is considered to behave normally. If the analyzed data is not within 1% of in terms of latency or not an exact match in result and can be considered not consistent with historical results and the node is considered behaving abnormally. Other percentages than 1% can be used. An analysis 208 is provided indicating abnormal behavior or normal behavior. Anomaly detector indicates to the controller whether a node is considered to behave normally or abnormally.

Referring back to FIG. 1B, if one or more nodes are considered to behave abnormally, the node or nodes will be flagged and controller 122 will communicate with FM 120 to disconnect the compromised node(s) from the fabric. If the node or nodes are considered to behave normally, controller 122 will communicate with FM 120 to continue to consider the node to be reliable and considered part of a fabric of nodes and able to accept workloads. For example, for Omni-Path, disconnecting a node can involve during sweep time interval (e.g., FM 120 checks connectivity of nodes and performs packet passing), FM 120 disconnects link(s) to node(s) considered abnormal and uses a command line to set up a new platform on the disconnected node(s).

Controller 122 can execute a behavior obfuscation system to attempt to create confusion that results in larger time that would be needed for an attacker to understand the operating parameters of a system of connected nodes. The behavior obfuscation system can dynamically change the execution environment of each node by modifying dynamic software behavior via modification of operating system, applying different performance parameters of platforms, applying different file systems (e.g., FAT, NTFS, ZFS, Ext, and so forth). Behavior obfuscation system can potentially confuse an attacker and an attacker would fail to generate the required attack for the existing vulnerabilities because the system behavior dynamically changes. Controller 122 can apply the pseudocode below to perform the behavior obfuscation system.

function resilience requirements from (Redundancy, Diversity, Shuffling
Rate)

for Phase p = 1 to #Phases; do

Controller → fabric = pseudo randomly select physical nodes
for each physical node n; do

For each v = 1 to #Versions; do

Select the workers node to run version v of application
and version v of platform

end for

end for

end for

end function

When the prescribed shuffling rate triggers a modification of the redundant nodes, the pseudocode provides for pseudo-randomly selecting a node among the redundant nodes and applying a version of an application coding language (e.g., Java, C, C++, Python, and so forth) and platform software (e.g., operating system and file system) as well as operating parameters (e.g., clock speeds, allocated memory, peak network interface bandwidth, and so forth). According to the pseudocode, the applied version can be changed for each available node at the shuffling rate. An available node can be a node that has not been disconnected for any reason such as anomaly detection from its workload processing. However, the applied version can be selected pseudo randomly from available versions so that in some cases, a node can run the same version even after shuffling. In some examples, when controller 122 is running on the node that executes the FM 120, Omni-Path “sweep time” can be the shuffling rate that controller 122 uses to perform the behavior obfuscation system.

In some embodiments, shuffling of node characteristics can also cause a controller 122 to move to another node. For example, at sweep time, FM 120 can instantiate the controller 122 on another node so that the controller location can change and intrusion of the controller can be more difficult.

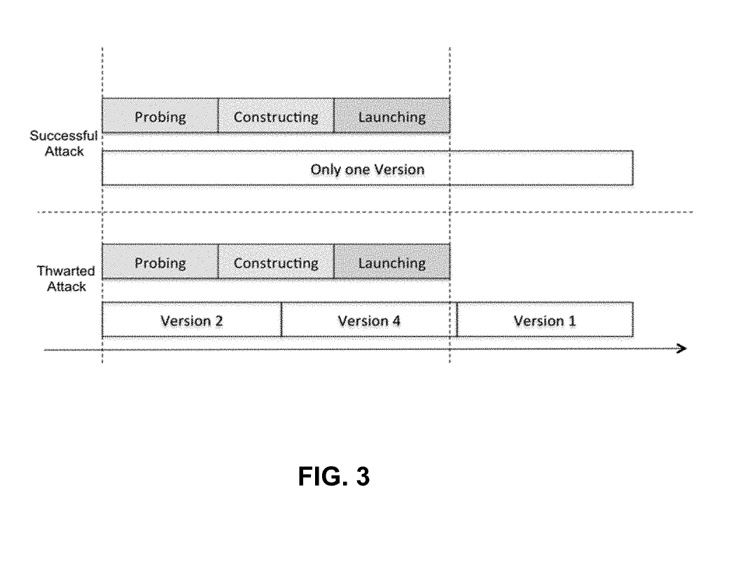

FIG. 3 depicts an example of attack phases. An attack can go through at least three phases: probing, constructing, and launching attack phases. If the environment stays static, the attacker can have sufficient time to identify existing vulnerabilities that can be exploited. However, if the life cycle for any application version is much shorter than the time it takes for the attacker to launch the attack, the attacker may not be able to succeed in exploiting any existing vulnerabilities in the application. For example, an application or platform software changes from version 2 to version 4 and to version 1. Hence, the application can be resilient to cyberattacks and will be able to continue to operate normally or with an acceptable degraded performance.

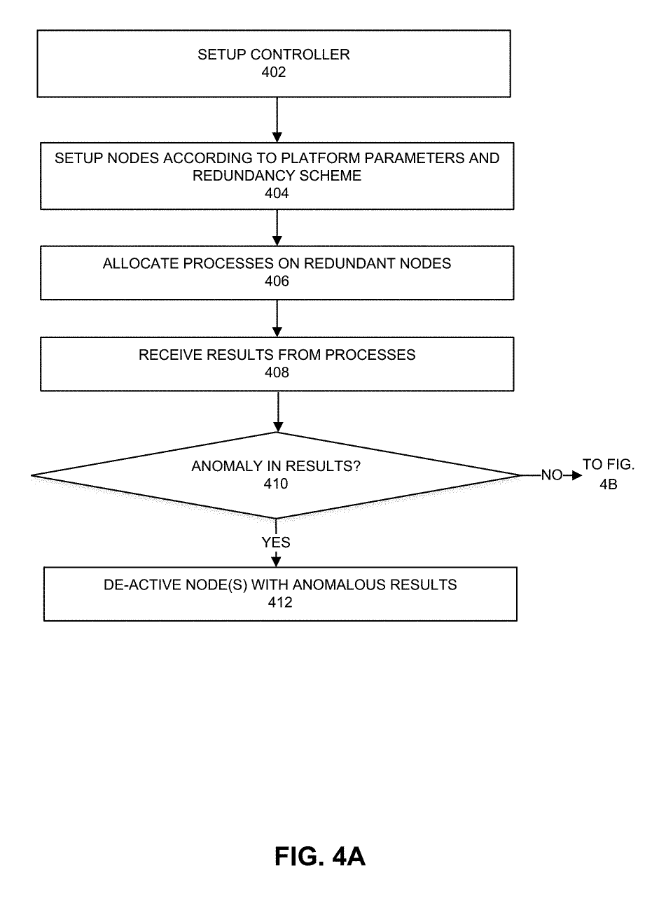

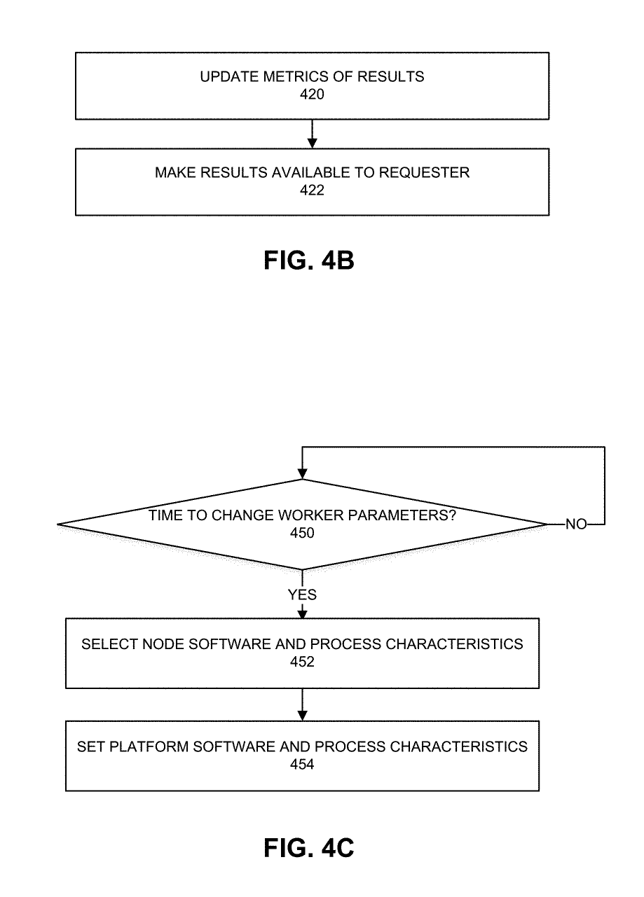

FIGS. 4A and 4B depict example processes. At 402, a controller can be setup for operation. For example, the controller can be loaded into a node and permitted to operate in a secure or trusted environment that is a region of memory that is accessible to limited processes including an administrator and the controller. At 404, nodes can be setup according to platform parameters and redundancy scheme. For example, platform parameters can be operating system, file system, compute performance parameters (e.g., CPU or GPU clock speed, memory allocation, storage allocation, or network interface speed), and accepted programming languages. A level of redundancy can specify a number of nodes to setup to operate according to the platform parameters.

At 406, processes can be allocated on the redundant nodes. For example, a process can be a workload or transaction to be performed using any compute resource of a node. Redundant nodes can perform the same functions based on the processes but using different platform parameters. However, in some cases, at least some but not all of the redundant nodes can use the same platform parameters. At 408, results are received from the processes. The processes can be performed on the redundant nodes. At 410, the results are analyzed to determine whether an anomaly is detected. For example, if results from a node provides a different result than that provided by a majority of other nodes, the node can be considered to provide an anomalous result. For example, a result can include one or more of: a computation result value or values, how much memory is used, central processing unit (CPU) or core utilization, input/output utilization, a secure shell (SSH) key from nodes (e.g., partition key (PKey)). For example, if a time to complete the process and provide a result is markedly different than times to complete the process by other nodes, then the result (and associated node) can be considered anomalous. In some cases, the result or its latency can be compared against prior results or latencies from performance of similar or the same process, and anomaly can be identified from substantial differences regardless of whether a majority of the same or similar results or latency was found. If an anomaly is detected, then 412 can follow.

At 412, the controller causes any node with an anomalous result to be deactivated. Accordingly, the controller will not use those deactivated nodes to perform workloads or communicate with those deactivated nodes.

Referring again to 410, if an anomaly is not detected, then 420 of FIG. 4B follows. At 420, results from processes can be used to update metrics of results. For example, a result from a particular process and platform parameters can be stored in a database for use in comparison against future results from the same or similar process and platform parameters to determine whether an anomaly occurred. At 422, the results can be made available to the requester. Any non-anomalous result from redundant nodes can be provided to a requester of the workload process.

FIG. 4C depicts an example process. At 450, a determination is made as to whether the current time is a time to change worker node parameters. For example, a shuffling rate specified in a trusted memory region can be set to specify when to modify platform parameters of redundant nodes. If the current time is a time to change worker node parameters, then 452 can follow. If the current time is not a time to change worker node parameters, then 450 can repeat. Note that if a node is currently executing a process, the execution of 452 can be delayed until after the process completes. At 452, node software and process characteristics can be selected. For example, selection of node software and process characteristics can include pseudo random selection of one or more of: CPU clock speed, GPU clock speed, memory allocation, storage allocation, network interface transmit and receive rates, operating system (e.g., Windows, Linux, iOS, MacOS, and any other operating system), virtual machine, file system, or programming languages (e.g., C, C++, Java, Python, JavaScript, and any other computing language). In some cases, one or more of software and process characteristics are not changed for a particular node or the same characteristics are chosen.

At 454, the platform software and process characteristics selected using 452 are applied to the nodes. In some cases, the controller can be migrated to a different node along with potential changes to software and process characteristics.

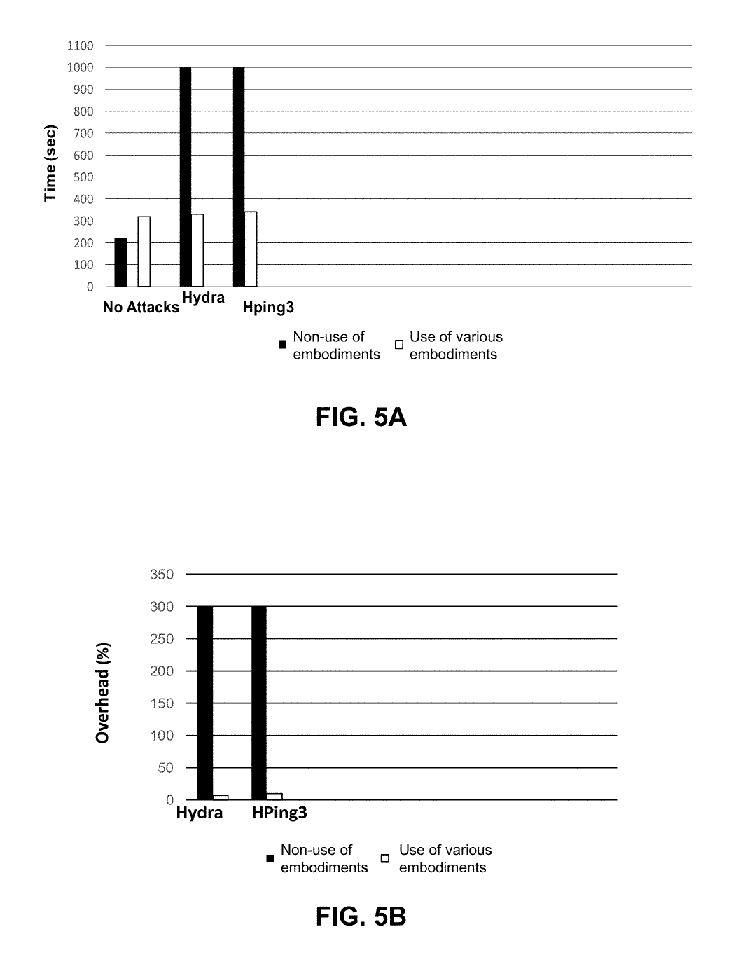

FIGS. 5A and 5B depict experimental results. To evaluate various embodiments, an HPC environment was used to perform MapReduce. Two different MapReduce implementations were used: MRS-MapReduce and Hadoop. During the evaluation, Map sessions are applied and then both Map and Reduce are applied for all Map outputs. When multiple files are used for MapReduce, there is a need to use a Map operation for the combined Map outputs since the Reduce function requires inputs are to be sorted. Table 1 below provides examples of file sizes and execution time with uses of some embodiments and without uses of some embodiments.

TABLE 1

| | | Execution | |
|---|---|---|---|
| | Execution | time on HPC | |
| File | time on HPC | without | |
| Size | using some | using some | Overhead |
| (MB) | embodiments | embodiments | (%) |
| 5 | 108 | 100 | 7 |
| 10 | 118 | 107 | 10 |
| 15 | 130 | 114 | 13 |
| 20 | 135 | 122 | 9 |
| 25 | 152 | 130 | 14 |
| 30 | 164 | 138 | 16 |
| 60 | 235 | 182 | 23 |
| 138 | 314 | 247 | 21 |

Various embodiments were tested against different attacks and their ability to continue to operate normally under successful attacks. Hydra (e.g., brute force password cracking software) and HPing3 (e.g., networking tool for sending custom TCP/IP packets for security auditing) were used to attack the system. When there is an attack (either insider or outsider), the system will fail completely or slow-down greatly under successful attacks when embodiments are not applied.

FIGS. 5A and 5B present respective execution time and overhead of some embodiments showing that the HPC systems not using embodiments would fail operation whereas systems using embodiments are still able to operate with a small amount of overhead. FIG. 5B shows that when there is an attack, the overhead using embodiments is negligible, namely, 2% for Hydra and 1% for HPing3 but respectively 12% and 32% for systems that do not use embodiments.

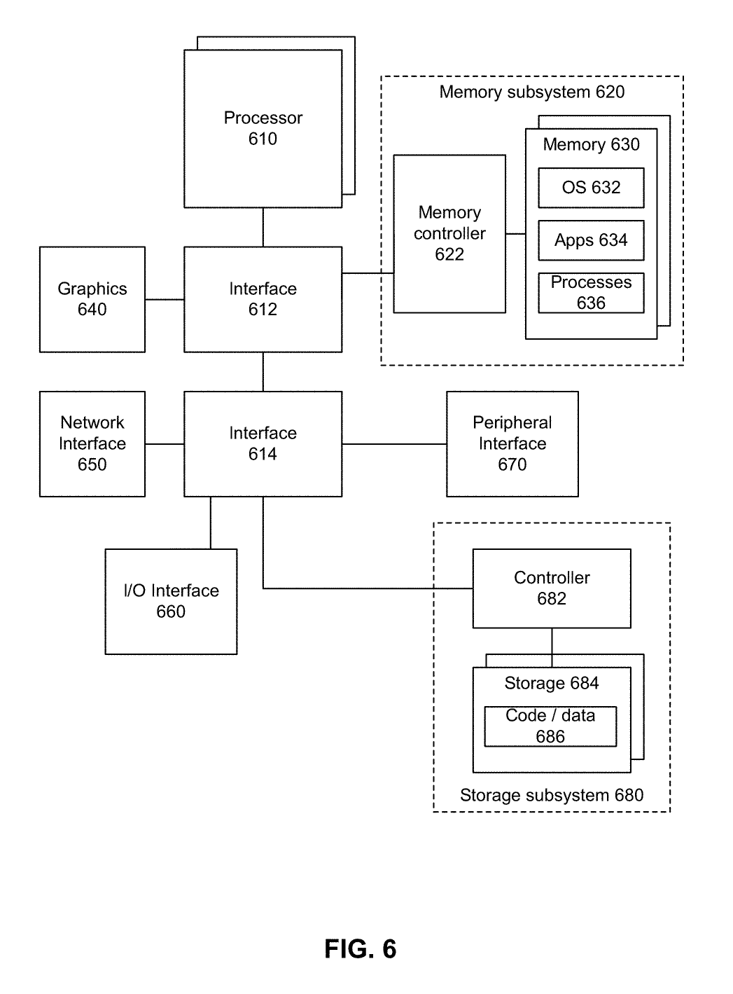

FIG. 6 depicts an example system. Various embodiments can be used with system 600. System 600 includes processor 610, which provides processing, operation management, and execution of instructions for system 600. Processor 610 can include any type of microprocessor, central processing unit (CPU), graphics processing unit (GPU), processing core, or other processing hardware to provide processing for system 600, or a combination of processors. Processor 610 controls the overall operation of system 600, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 600 includes interface 612 coupled to processor 610, which can represent a higher speed interface or a high throughput interface for system components that needs higher bandwidth connections, such as memory subsystem 620 or graphics interface components 640. Interface 612 represents an interface circuit, which can be a standalone component or integrated onto a processor die. Where present, graphics interface 640 interfaces to graphics components for providing a visual display to a user of system 600. In one example, graphics interface 640 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 640 generates a display based on data stored in memory 630 or based on operations executed by processor 610 or both. In one example, graphics interface 640 generates a display based on data stored in memory 630 or based on operations executed by processor 610 or both.

Memory subsystem 620 represents the main memory of system 600 and provides storage for code to be executed by processor 610, or data values to be used in executing a routine. Memory subsystem 620 can include one or more memory devices 630 such as read-only memory (ROM), flash memory, one or more varieties of random access memory (RAM) such as DRAM, or other memory devices, or a combination of such devices. Memory 630 stores and hosts, among other things, operating system (OS) 632 to provide a software platform for execution of instructions in system 600. Additionally, applications 634 can execute on the software platform of OS 632 from memory 630. Applications 634 represent programs that have their own operational logic to perform execution of one or more functions. Processes 636 represent agents or routines that provide auxiliary functions to OS 632 or one or more applications 634 or a combination. OS 632, applications 634, and processes 636 provide software logic to provide functions for system 600. In one example, memory subsystem 620 includes memory controller 622, which is a memory controller to generate and issue commands to memory 630. It will be understood that memory controller 622 could be a physical part of processor 610 or a physical part of interface 612. For example, memory controller 622 can be an integrated memory controller, integrated onto a circuit with processor 610.

While not specifically illustrated, it will be understood that system 600 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a HyperTransport or industry standard architecture (ISA) bus, a small computer system interface (SCSI) bus, a universal serial bus (USB), or an Institute of Electrical and Electronics Engineers (IEEE) standard 1364 bus.

In one example, system 600 includes interface 614, which can be coupled to interface 612. In one example, interface 614 represents an interface circuit, which can include standalone components and integrated circuitry. In one example, multiple user interface components or peripheral components, or both, couple to interface 614. Network interface 650 provides system 600 the ability to communicate with remote devices (e.g., servers or other computing devices) over one or more networks. Network interface 650 can include an Ethernet adapter, wireless interconnection components, cellular network interconnection components, USB (universal serial bus), or other wired or wireless standards-based or proprietary interfaces. Network interface 650 can transmit data to a remote device, which can include sending data stored in memory. Network interface 650 can receive data from a remote device, which can include storing received data into memory.

In one example, system 600 includes one or more input/output (I/O) interface(s) 660. I/O interface 660 can include one or more interface components through which a user interacts with system 600 (e.g., audio, alphanumeric, tactile/touch, or other interfacing). Peripheral interface 670 can include any hardware interface not specifically mentioned above. Peripherals refer generally to devices that connect dependently to system 600. A dependent connection is one where system 600 provides the software platform or hardware platform or both on which operation executes, and with which a user interacts.

In one example, system 600 includes storage subsystem 680 to store data in a nonvolatile manner. In one example, in certain system implementations, at least certain components of storage 680 can overlap with components of memory subsystem 620. Storage subsystem 680 includes storage device(s) 684, which can be or include any conventional medium for storing large amounts of data in a nonvolatile manner, such as one or more magnetic, solid state, or optical based disks, or a combination. Storage 684 holds code or instructions and data 686 in a persistent state (i.e., the value is retained despite interruption of power to system 600). Storage 684 can be generically considered to be a “memory,” although memory 630 is typically the executing or operating memory to provide instructions to processor 610. Whereas storage 684 is nonvolatile, memory 630 can include volatile memory (i.e., the value or state of the data is indeterminate if power is interrupted to system 600). In one example, storage subsystem 680 includes controller 682 to interface with storage 684. In one example controller 682 is a physical part of interface 614 or processor 610 or can include circuits or logic in both processor 610 and interface 614.

A power source (not depicted) provides power to the components of system 600. More specifically, power source typically interfaces to one or multiple power supplies in system 600 to provide power to the components of system 600. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 600 can be implemented using interconnected compute sleds of processors, memories, storages, network interfaces, and other components. High speed interconnects can be used such as PCIe, Ethernet, or optical interconnects (or a combination thereof).

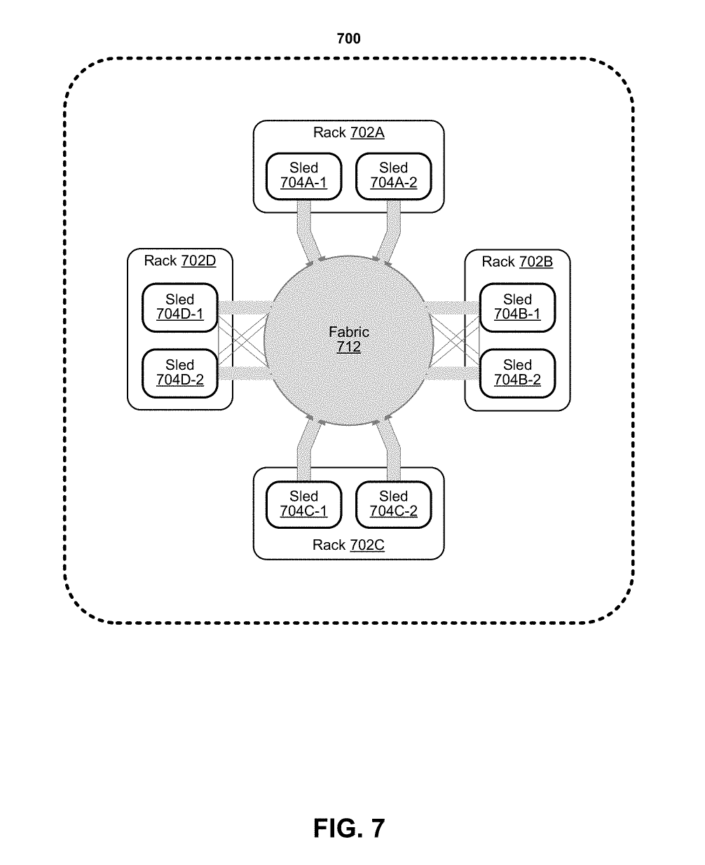

FIG. 7 depicts an example of a data center. Various embodiments can be used in the example data center. As shown in FIG. 7, data center 700 may include a fabric 712. Fabric 712 may generally include a combination of optical or electrical signaling media (such as optical or electrical cabling or lines) and optical or electrical switching infrastructure via which any particular sled in data center 700 can send signals to (and receive signals from) each of the other sleds in data center 700. The signaling connectivity that fabric 712 provides to any given sled may include connectivity both to other sleds in a same rack and sleds in other racks. Data center 700 includes four racks 702A to 702D and racks 702A to 702D house respective pairs of sleds 704A-1 and 704A-2, 704B-1 and 704B-2, 704C-1 and 704C-2, and 704D-1 and 704D-2. Thus, in this example, data center 700 includes a total of eight sleds. Fabric 712 can provide each sled signaling connectivity with one or more of the seven other sleds. For example, via fabric 712, sled 704A-1 in rack 702A may possess signaling connectivity with sled 704A-2 in rack 702A, as well as the six other sleds 704B-1, 704B-2, 704C-1, 704C-2, 704D-1, and 704D-2 that are distributed among the other racks 702B, 702C, and 702D of data center 700. The embodiments are not limited to this example.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. It is noted that hardware, firmware and/or software elements may be collectively or individually referred to herein as “module,” “logic,” “circuit,” or “circuitry.”

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of steps may also be performed according to alternative embodiments. Furthermore, additional steps may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”’

What is claimed is:

1. An apparatus comprising:
an interface to a network;
a memory; and
at least one processor, wherein the at least one processor is to:
select platform parameters supported by a plurality of nodes;
provide workload requests to the plurality of nodes;
receive results from the workload requests;
determine whether any result is a majority or consistent with historical results; and
disable the node associated with a result is not a majority or not consistent with historical results.

2. The apparatus of claim 1, wherein the workload requests provided to the plurality of nodes request a same operation and the platform parameters are different on at least two nodes of the plurality of nodes.

3. The apparatus of claim 1, wherein the platform parameters comprises a software platform and application language and wherein the platform parameters are different on at least two nodes.

4. The apparatus of claim 1, wherein to determine whether any result is a majority or consistent with historical results, the at least one processor is to analyze one or more of workload completion latency or results.

5. The apparatus of claim 1, wherein to determine whether any result is a majority or consistent with historical results, the at least one processor is to compare one or more of workload completion latency or results with prior workload completion latency or results for a same workload using same platform parameters.

6. The apparatus of claim 1, wherein to disable the node associated with a result is not a majority or not consistent with historical results, the at least one processor is to not permit workloads to be performed on the disabled node.

7. The apparatus of claim 1, wherein the at least one processor is to select platform parameters of at least one node using pseudo-random selection.

8. The apparatus of claim 7, wherein the pseudo-random selection is to change or not change platform parameters of at least one node.

9. The apparatus of claim 1, wherein the platform parameters comprise one or more of: operating system, virtual machine, file system, programming language of the workload, central processing unit (CPU) clock speed, graphics processing unit (GPU) clock speed, memory allocation, storage allocation, or network interface transmit and receive rates.

10. The apparatus of claim 1, wherein the network comprises an Omni-Path compatible fabric.

11. A method comprising:
allocating platform parameters to a set of nodes connected to a fabric, wherein platform parameters of at least two nodes are different;
issuing a service request to recipient nodes in the set of nodes, the service request comprising a request written in a computing language supported by its recipient node;
receiving results from the recipient nodes;
determining if a result is consistent with a majority of results or consistent with historical results; and
disconnecting a node among the recipient nodes associated with the result that is consistent with the majority of results or not consistent with historical results.

12. The method of claim 11, wherein allocating platform parameters to a set of nodes connected to a fabric comprises:
allocating one or more of operating system, file system, programming language supported and performance specification to nodes in the set of nodes, wherein one node uses different platform parameters than platform parameters of another node.

13. The method of claim 11, wherein the service request issued to recipient nodes in the set of nodes requests performance of same functions.

14. The method of claim 11, wherein the determining if a result is consistent with a majority of results or consistent with historical results comprises determining if a time to service request completion or result from a node vary from a time to service request completion or result from another node in the set of nodes.

15. The method of claim 11, wherein the determining if a result is consistent with a majority of results or consistent with historical results comprises determining if a time to service request completion differs from one or more prior executions of the service request.

16. The method of claim 11, further comprising:
selecting a node from the set of nodes;
selecting platform parameters pseudo-randomly; and
modifying the platform parameters of the selected node using the selected platform parameters.

17. The method of claim 11, comprising:
selecting a node from the set of nodes to execute a controller and migrating the controller to the selected node.

18. A system comprising:
an interface to a communication fabric;
a memory; and
at least one processor, the at least one processor is communicatively coupled to the interface and the memory, wherein the at least one processor is to:
select a set of nodes;
select platform parameters for the nodes in a restricted access environment; and
cause the nodes to utilize the selected platform parameters, wherein the platform parameters for a node are different than platform parameters for another node.

19. The system of claim 18, wherein the at least one processor is to:
issue workload requests to the set of nodes in accordance with the applicable programming language for the set of nodes;
determine whether a result is consistent with a majority of results or consistent with historical results arising from performance of the workload requests by the set of nodes; and
cause disconnection of a node not consistent with a majority of results or not consistent with historical results.

20. The system of claim 18, wherein the at least one processor is to periodically modify platform parameters for at least one of the nodes.
